(19) United States
(12) Patent Application Publication
(10) Pub. No.: US 2006/0270297 A1
(43) Pub. Date: Nov. 30, 2006

(54) Reflective woven band

(76) Inventor: Chen-Chou Hsieh, Kaohsiung City (TW)

Correspondence Address: BIRCH STEWART KOLASCH & BIRCH, PO BOX 747, FALLS CHURCH, VA, 22040-0747, US

(21) Appl. No.: 11/437,736

(22) Filed: May 22, 2006

(30) Foreign Application Priority Data
May 24, 2005 (TW) 094208416

(51) Int. Cl. B32B 5/26; D03D 15/00

(52) U.S. Cl. 442/243; 442/301

(57) ABSTRACT

A reflective woven band includes a woven band body which has one or more reflective portions. The reflective portion includes a reflective strip woven on the body in an integrated manner. The reflective portion thus formed is wash-resistant and less likely to wear off or break away. It also can generate a three-dimensional visual effect to provide improved light reflection and enhance decorative and safety alert functions.

### FIELD OF THE INVENTION

The present invention relates to a reflective woven band and particularly to a woven band adopted for use on zippers, clothes, colored bands and the like to provide decorative and safety alert functions.

### BACKGROUND OF THE INVENTION

The conventional woven bands may be used on household goods such as zippers, decorative hems on clothes, trunk sliding fasteners, colored bands and the like for ornamental purpose. Some woven bands have reflective flakes attached thereon to provide safety alert function and enhance decorative effect.

However there are still problems when the conventional woven bands mentioned above are actually used on the household goods, notably:

1. The reflective flakes usually are attached to the woven band by stitching or reflective patterns are formed on the woven band by transfer printing or direct printing. The reflective flakes thus formed easily wear off or break away from the woven band after use for a period of time due to external impact, abrasion, washing or the like. Hence they have to be re-sewed or replaced periodically. Asides from shortening the life span, it also creates a lot of inconveniences.

2. The conventional woven band with the reflective flakes attached thereon can merely produce a simple and plane reflection under light projection without generating three-dimensional visual effect. It cannot provide more appealing decorative effect, and safety alert function also is less desirable.

### SUMMARY OF THE INVENTION

Therefore the primary object of the present invention is to provide a reflective woven band to overcome the disadvantages of the conventional reflective woven band such as poorer wash-resistance, easier wearing and breaking off, not desirable decorative and safety alert effects and the like.

To achieve the foregoing object, the reflective woven band according to the invention includes a woven band body which has one or more reflective portions. The reflective portion is a reflective strip woven on the body in an integrated manner.

By means of the structure set forth above the invention can achieve the following effects:

1. Enhanced bonding: As the reflective strip is woven on the body in an integrated manner, it is less likely to break away or wear off when in use. The life span is longer.

2. Improved decorative effect: The reflective portion can generate a three-dimensional visual effect to improve light reflection. Hence it can provide more desirable decorative and safety alert functions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a woven band of the invention.

FIG. 2 is a schematic view of a woven band of the invention adopted for use on a zipper.

### DETAILED DESCRIPTION OF THE PREFERRED EMBODIMENT

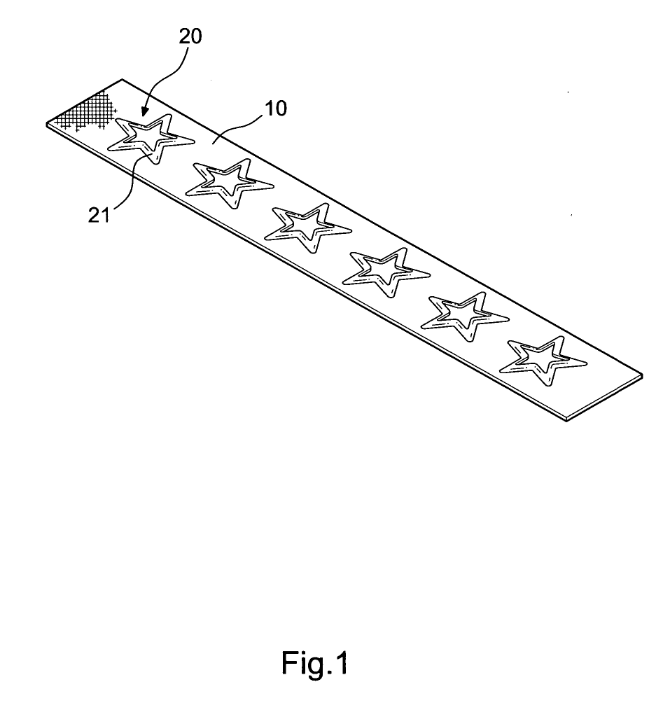

Please refer to FIG. 1, the reflective woven band according to the invention mainly includes a woven band-like body 10 which has one or more reflective portions 20 located thereon. The reflective portion 20 is formed by weaving an elongate reflective strip 21 on the body 10 in selected patterns such as graphics, characters or the like. Weaving of the reflective strip 21 on the body 10 can be accomplished by knitting or embroidering through a knitting machine, embroidering machine or the like so that the reflective strip 21 and the band 10 are bonded in an integrated manner. Therefore the reflective portion 20 can present the patterns with a three-dimensional visual effect.

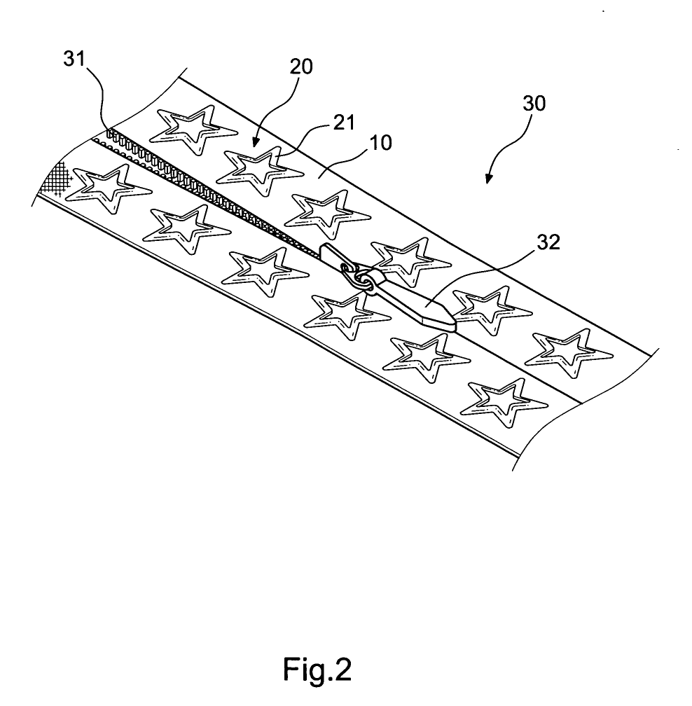

The reflective woven band of the invention can be used on general household goods such as zippers, hems of clothes, sliding fasteners on the trunks, colored bands and the like. FIG. 2 illustrates an embodiment with the woven band used on a zipper 30.

Two woven band bodies 10 of the invention are laid in a juxtaposed manner to serve as zipper tapes on two sides with chain teeth 31 located on one edge thereof that are engageable with each other. A zipper tab 32 is provided and movable reciprocally to couple or separate the two chain teeth 31. The zipper 30 thus formed can be used on clothes, trousers, trunks and the like. The reflective strip 21 of the reflective portion 20 can provide decorative and safety alert functions.

In short, the reflective woven band of the invention has the following features;

1. The reflective strip 21 of the reflective portion 20 is woven on the body 10 in an integrated manner. It has an improved bonding effect, and is less likely to break away or wear off caused by washing, external impact or abrasion when in use. Life span is longer, and convenience improves.

2. The reflective strip 21 of the reflection portion 20 woven on the body 10 has patterns formed thereon by embroidering or knitting. A three-dimensional visual effect can be generated to provide improved decorative effect. It also can provide a better reflection, thus an improved safety alert function can be achieved.

Because of the features set forth above, the reflective portion 20 on the reflective woven band is less likely to wear off or break away. It also can generate a more appealing three-dimensional decorative effect.

What is claimed is:

1. A reflective woven band comprising a woven band body which has at least one reflective portion, the reflective portion including a reflective strip woven on the body in an integrated manner.
